(19) United States
(12) Patent Application Publication
(10) Pub. No.: US 2018/0038597 A1
(43) Pub. Date: Feb. 8, 2018

(54) DOMESTIC APPLIANCE HAVING A DOOR THAT CAN BE LOWERED IN A STOWAGE SPACE, SAID DOOR HAVING AN ELLIPTICAL SLOT FOR MOVING A SUPPORTING BOW OF A DOOR SUPPORTING UNIT

(71) Applicant: BSH Hausgeräte GmbH, Munich (DE)

(72) Inventors: Konrad Bleier, Weisenbach (DE); Martin Brunner, Pforzheim (DE); Manfred Hintermayer, Karlsruhe (DE); Heiko Meyer, Königsbach-Stein (DE); Kerstin Sickert, Bretten (DE); Reinhard Wiedenmann, Weingarten (DE)

(21) Appl. No.: 15/549,389

(22) PCT Filed: Feb. 5, 2016
(86) PCT No.: PCT/EP2016/052473

§ 371 Date: Aug. 8, 2017

(30) Foreign Application Priority Data
Apr. 13, 2015 (DE) 10 2015 206 577.4

(51) Int. Cl. F24C 15/02; A47L 15/42

(52) U.S. Cl. CPC F24C 15/023; A47L 15/4261; F24C 15/026; E05Y 2900/30

(57) ABSTRACT

A domestic appliance includes a housing having an accommodating space and a door arranged pivotably to the housing so as to be movable to a closed state in which a loading opening of the accommodating space of the housing is closeable and an opened state in which the door is lowered in a stowage space in the housing. A guiding device is coupled to the door to guide a movement of the door into and out of the stowage space. The guiding device includes a supporting unit which is mounted for rotation about an axis of rotation and includes a supporting bracket, and guiding elements which are mounted rotatably on the supporting bracket. The supporting bracket has a displacement slot defined by a varying radius and configured to rotate the supporting bracket about the axis of rotation with a rotational movement which deviates from a segment of a circular path.

The invention relates to a domestic appliance having a housing, which surrounds an accommodating space. The domestic appliance further comprises a door, with which a loading opening of the accommodating space can be closed and which is arranged pivotably in relation to the housing. In the opened state the door can be lowered in a stowage space in the housing, wherein the door is coupled to a guiding device. The movement in and out of the stowage space is guided using the guiding device. The guiding device comprises at least one supporting unit, which is mounted rotatably about an axis of rotation and on which guiding elements are arranged. Furthermore, the invention also relates to a method for opening and closing a door of a domestic appliance which can be lowered in a stowage space.

DE 10 2008 010 526 A1 discloses a domestic appliance device having at least one door unit. The door unit is fastened to a housing of the domestic appliance with hinges and can be pivoted in relation thereto and in the opened state can be lowered in a stowage space embodied below the accommodating space. The hinges also comprise a U-shaped bow as a hinge part, on which two rollers are mounted rotatably. The bow is rigid per se and can be pivoted about an axis of rotation.

EP 2 57 378 A1 also discloses a domestic appliance with a lowerable appliance door. A hinge with a U-shaped bow as a supporting unit is also embodied here in the form of a hinge rocker with two rollers. This hinge rocker is likewise rigid per se, but arranged in a rotatable manner on a hinge housing.

The same is also known from EP 2 574 712 A1, wherein provision is likewise made in the embodiment of the hinge for a hinge housing and a supporting unit arranged rotatably thereupon in the form of a U-shaped bow, which is a hinge hook.

As a result, what is known as a technical part which has guide wheel tracks for this supporting part and accommodates the rollers when the door is lowered is to be dimensioned accordingly. Furthermore, on account of this embodiment with specific door settings, when the door is already partially opened and at the same time moved into the stowage space, a distance between the door leaf of the front top edge at the front, which delimits the stowage space at the front, is very small. This may result in the door leaf striking the same with the further closing movement or upon opening. In respect of this vertical overall height, the critical points are the flange on the lower area and thus on the lower edge and the partition floor of the said technical part, which delimits the stowage space from above. This partition floor forms in particular an upper cover of the stowage space. In the known embodiments, at the start of the opening movement the door has a smaller distance from the flange or from the front edge of the partition floor. From the middle to the end of the opening movement of the door the smallest vertical distance occurs between the door and the partition floor.

It is the object of the present invention to create a domestic appliance and a method for opening and closing a door of a domestic appliance, in which the motion control is improved and a smaller stowage space can be embodied for the door.

This object is achieved by a domestic appliance and a method as claimed in the independent claims.

An inventive domestic appliance comprises a housing which surrounds an accommodating space. Furthermore, the domestic appliance has a door, with which a loading opening of the accommodating space can be closed. The door is arranged so as to be pivotable in relation to the housing and in the opened state the door can be lowered in a stowage space in the housing. The door is coupled to a guiding device, with which the movement into and out of the stowage space is guided. The guiding device has at least one supporting unit, which is mounted rotatably about an axis of rotation and on which guiding elements are arranged.

One essential idea behind the invention is that the supporting bow has a displacement slot which is embodied with a varying radius and is thus not straight at least in sections, by which displacement slot the supporting bow can be rotated about the axis of rotation with a rotational movement which deviates from a segment of a circular path. By means of this embodiment, the movement behavior of the door when pivoting can be changed such that the space requirement in the vertical direction can be reduced so that the stowage space can be embodied smaller especially in terms of height. The displacement slot is thus a guide for the supporting bow, by means of which a movement of the supporting bow which deviates from a circle is predetermined and when viewed in the vertical direction a flatter path is thus predetermined than with a segment of a circular path. The radius of the displacement slot is larger at all points which differ from a point representing a minimum slot than at this minimum point. In particular, the displacement slot is thus in effect flatter than a circle with a constant radius according to the radius at this minimum point.

The displacement slot preferably has an elliptical limiting contour, as a result of which the afore-cited advantages are benefited. One such embodiment of the slot which is symmetrical to the axis of the ellipse also permits a very uniform and therefore smooth pivoting of the door when moving into the stowage space.

The hinge axis of rotation or the axis of rotation on the appliance side is preferably arranged to be fixed. As a result, the complexity of the motion control of the supporting bow is reduced.

The displacement slot is preferably embodied as a cutout in a coupling element. As a result, it is embodied to be dimensionally stable and large forces when moving the door can be absorbed and the motion control can be kept permanently precise.

The coupling element is preferably an integral part of the supporting bow. As a result, the supporting bow can be attached to the axis of rotation without an additional part.

In particular, the coupling element of the supporting bow and a basic part of the supporting bow which has the guiding elements are connected rotatably with one another and can thus move or pivot in relation to one another. As a result, the motion control is especially simplified and an especially compact design of the stowage space in terms of its height is achieved. In particular, the coupling element can only be displaced in a straight line horizontally, as a result of which the motion sequences are easier and minimizing the installation space of the stowage space is improved again.

Provision is made in particular for the supporting bow to be embodied to be rigid per se. The distance between the guiding elements and/or the distance between the guiding elements and the axis of rotation is then unchanged across the entire movement path.

The displacement slot preferably has a mechanical connecting structure, which is embodied to mechanically couple to a complementary connecting structure on an appliance part which has the axis of rotation and is external to the supporting bow. This is thus particularly advantageous in that no unwanted slipping or sliding in relation to the coupling element takes place along the path which is predetermined by the displacement slot. As a result, the precision of the motion control of the door is increased.

The connecting structures are preferably embodied as toothings which mesh with one another. As a result, particularly advantageous mechanical force transmissions are achieved and the afore-cited advantages are fulfilled to a special degree.

The supporting bow is preferably embodied to be U-shaped.

The guiding elements are in particular rollers.

With an inventive method for opening and closing a door of a domestic appliance, which is embodied with a housing which surrounds an accommodating space, and with a door, with which a loading opening of the accommodating space can be closed and which is arranged so as to be pivotable in relation to the housing, in the opened state of the door this is lowered in a stowage space in the housing. The door is coupled to a guiding device, with which the motion control into and out of the stowage space is guided. A supporting unit of the guiding device is mounted rotatably about an axis of rotation. Guiding elements are arranged mounted rotatably on a supporting bow of the supporting unit. One essential idea is that the supporting bow is embodied with a displacement slot embodied with a varying radius, by means of which when the door is moved the supporting bow is rotated about the axis of rotation with a rotational movement which deviates from a segment of a circular path.

On account of its shape the displacement slot specifies an arched path, in particular an entirely arched path, by means of which the supporting bow then moves about the axis of rotation of the supporting unit.

As a result, a supporting bow of a simple design and with a high mechanical loading can also be provided, and accordingly the stowage space can be embodied to be more compact, particularly reduced in terms of its height, since less space is required on account of the thus modified movement behavior of the supporting unit when the door is moved.

The indications “top”, “bottom”, “front”, “rear”, “horizontal”, “vertical”, “depth direction”, “width direction”, “height direction” indicate the positions and orientations existing in the case of normal use and normal arrangement of the appliance and in the case of an observer standing in front of the appliance and looking in the direction of the appliance.

Further features of the invention will emerge from the claims, the figures and the description of the figures. The features and feature combinations mentioned above in the description and the features and feature combinations mentioned below in the description of the figures and/or simply shown in the figures can be used not only in the combination specified in each instance but also in other combinations or alone without departing from the scope of the invention. Embodiments of the invention that are not specifically illustrated and explained in the figures but which emerge and can be generated as a result of separate feature combinations from the described embodiments should therefore also be considered to be comprised and disclosed. Explanations and combinations of features which therefore do not have all features of an originally formulated independent claim are also to be regarded as disclosed.

Exemplary embodiments of the invention are explained in greater detail below on the basis of schematic drawings, in which:

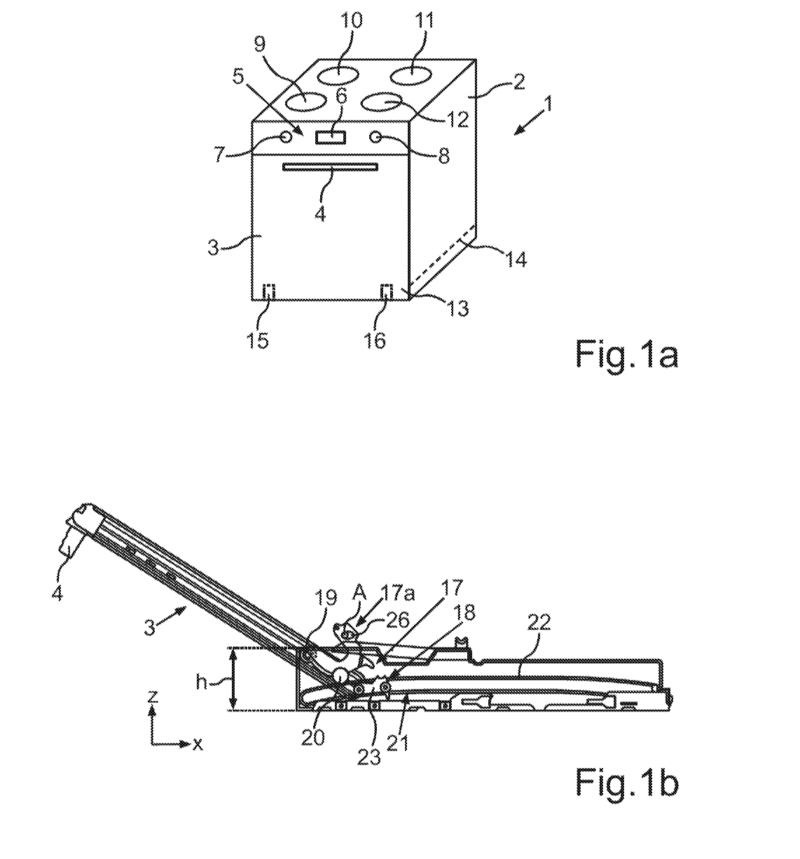

FIG. 1a shows a perspective view of an exemplary embodiment of an inventive household appliance;

FIG. 1b shows a side view of an exemplary embodiment of the domestic appliance with a partially opened door;

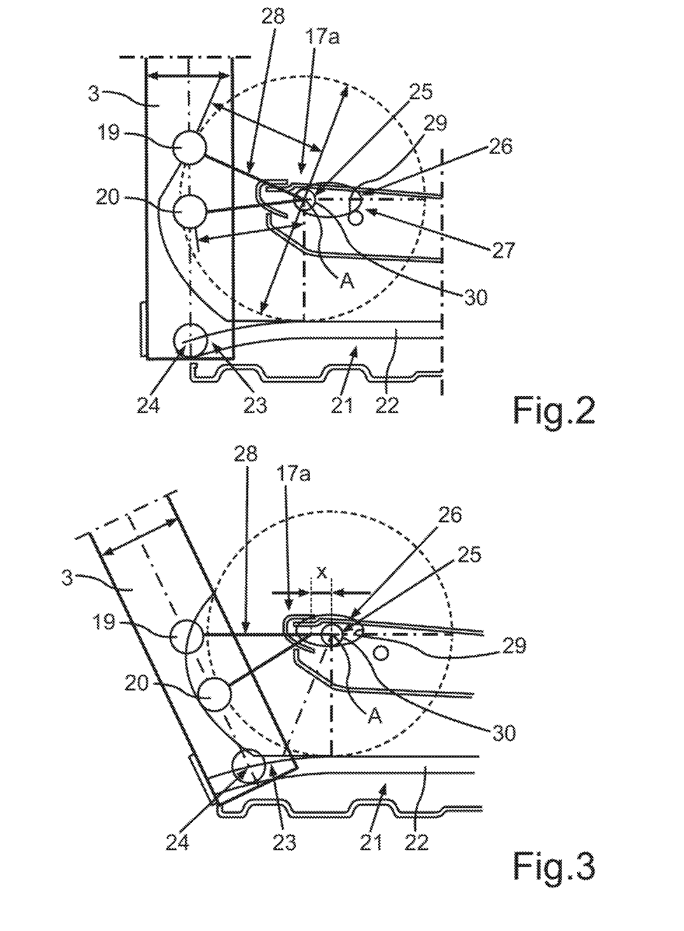

FIG. 2 shows a vertical sectional view of the domestic appliance with a supporting unit and with a closed door; and

FIG. 3 shows a vertical sectional view of the domestic appliance according to FIG. 2 with a partially opened door.

Identical or functionally identical elements are provided with the same reference characters in the figures.

FIG. 1a shows a schematic perspective view of a domestic appliance 1 embodied as an oven. The domestic appliance 1 comprises a housing 2, in which a cooking compartment limited by a muffle (not shown) is embodied. Food can be introduced into the cooking compartment for preparation. The cooking compartment can be closed at the front by a door 3, which is shown in the closed end position in FIG. 1a. A handle 4 is embodied on the front of the door 3.

Furthermore, the oven comprises a control device 5, which in terms of position and display, only has a display unit 6 and control elements 7 and 8 for instance.

Furthermore, cooking zones 9, 10, 11 and 12 shown purely by way of example are likewise shown in terms of position and number.

The door 3 can be introduced or lowered into the housing 2 in its lower region 13, which is the case when the door 3 is transferred from the closed end position shown in Fig. la into the completely open end position. The door 3 is then arranged lowered in a gap in the housing 2, wherein to this end on account of this gap a stowage space 14 arranged below the cooking compartment and separated herefrom by a corresponding partition wall is embodied.

The door 3 is connected using door hinges 15 and 16 identified and shown by way of example and can be moved pivotably in and out of the said stowage space 14 by way hereof.

FIG. 1b shows a side view of the domestic appliance 1 in the lower region with a partially opened door 3. A supporting unit 17 is shown. The supporting unit 17 represents a hinge hook of a hinge 15 or 16. The hinges 15 and 16 are embodied to be especially of the same construction and functionally identical so that the subsequent description relating to one of the two hinges also applies in each case to the other.

In addition to a respectively provided supporting unit 17 the hinges 15 and 16 also have a hinge housing which is not shown here in more detail. These hinges 15 and 16 are in each case assigned to a guiding device 18 in respect of the components and the functions. The movement of the door 3 is controlled using these guiding devices 18 and is as a result correspondingly coupled so that it is guided into and out of the stowage space 14. The supporting unit 17 comprises an especially U-shaped supporting bow 17a. The supporting bow 17a can be rotated about a center of rotation, which is arranged on an axis of rotation A, which extends at right angles to the plane of the figure in Fig. lb. The supporting unit 17 is also connected to the hinge housing and can be pivoted in relation to the hinge housing. The supporting unit 17 comprises two guiding elements 19 and 20, which are embodied as rollers and are arranged rotatably mounted on the supporting bow 17a.

A vertical height h is indicated in FIG. 1b, which represents the extent of a technical part 21, which is associated with the guiding device 18. The technical part 21 describes especially one component, which also then has a groove or a guide track 22, in which the guiding elements 19 and 20 are guided when the door 3 is slid into the stowage space 14.

A slot carriage 23 which slides along the guide track 22 and is associated with the guiding device 18 is also provided for the corresponding guide.

FIG. 2 shows a simplified vertical sectional representation of the domestic appliance 1, wherein the lower region with the door 3 is shown here as a partial cutout. The door 3 is shown here in the closed stage, as also in Fig. la. It is apparent that the supporting bow 17a has a base part 28, on which the two guiding elements 19 and 20 embodied as rollers are arranged. This base part 28 is rigid per se and can thus not change shape. It is embodied in particular from one single part.

In the exemplary embodiment shown, in addition to the base part 28 the supporting bow 17a also comprises a coupling element 27. The coupling element 27 is embodied for coupling the entire supporting bow 17a to an appliance component 25 which is external to the supporting bow. The appliance component 25 is arranged fixedly in the domestic appliance 1 and has the axis of rotation, about which the supporting bow 17a rotates. As shown in the view in FIG. 2, the coupling element 27 has a displacement slot 26, which is embodied as a cutout in this coupling element 27. It is apparent that the displacement slot 26 has a limiting contour in the form of an ellipse. A displacement slot 26 is thus embodied on the side of the supporting bow, which specifies an entirely specific movement path of the supporting bow about the axis of rotation A. The supporting bracket 17a thus performs a rotational movement about this axis of rotation A, which differs from a segment of a circular path, since on account of the elliptical shape the limiting contour of the displacement slot 26 prespecifies a completely arched path which is embodied with a varying radius.

As apparent in FIG. 2, with a closed door 3, the coupling element 27 is arranged such that the appliance component 25 with the axis of rotation A is positioned at a narrow end of this elliptical shape.

FIG. 2 further also shows a bearing lining 24, in particular of the slot carriage 23, which is connected to the door 3.

Based on the position of the door 3 shown in FIG. 2, this is now opened, as shown in FIG. 3. The supporting bow 17a with the displacement slot 26 moves here relative to the appliance component 25 and completes the corresponding rotational movement about the axis of rotation A on account of the elliptical shape of the slot 26.

As is apparent to this end in FIG. 3, the displacement slot 26 moves tangentially about the center of rotation predetermined by the axis of rotation A by means of the opening movement of the door 3. This produces a horizontal straight longitudinal motion of the base part 28 and thus of the hinge arm at the height of this center of rotation of the axis of rotation A. This longitudinal motion is shown by the distance x in FIG. 3. As is apparent, the embodiment of the supporting bow 17a with its base part 28 and the coupling element 27 is embodied such that in this vertical sectional view, during the movement of the door 3, the orientation of the displacement slot 26 remains the same and this thus does not in effect rotate in its orientation.

In particular, provision is made for the base part 28 then to rotate in relation to this coupling element 27.

In this embodiment, the center of rotation of the hinge, which is predetermined by the axis of rotation A, is thus not arranged variably but instead fixed in the domestic appliance 1. Provision is preferably made for a mechanical coupling to be embodied between the coupling element 27 and the appliance component 25. In particular, a respective mechanical connecting structure is embodied here, which is preferably embodied as meshing toothings 29 and 30. On account of this gear train geometry, the toothing 29 of the displacement slot 26 thus engages in the toothing 30 of the appliance component 25.

### List of Reference Characters

1 Oven

2 Housing

3 Door

4 Handle

5 Control device

6 Display unit

7 Control element

8 Control element

9 Cooking zone

10 Cooking zone

11 Cooking zone

12 Cooking zone

13 Region

14 Stowage space

15 Door hinge

16 Door hinge

17 Supporting unit

17a Supporting bow

18 Guiding device

19 Guiding element

20 Guiding element

21 Technical part

22 Guide track

23 Slot carriage

24 Bearing lining

25 Appliance component

26 Displacement slot

27 Coupling element

28 Base part

29 Toothing

30 Toothing

1-12. (canceled)

13. A domestic appliance, comprising:
a housing having an accommodating space,
a door arranged pivotably in relation to the housing so as to be movable to a closed state in which a loading opening of the accommodating space of the housing is closeable and an opened state in which the door is lowered in a stowage space in the housing, and
a guiding device coupled to the door to guide a movement of the door into and out of the stowage space, said guiding device including a supporting unit which is mounted for rotation about an axis of rotation and includes a supporting bracket, and guiding elements which are mounted rotatably on the supporting bracket, said supporting bracket having a displacement slot defined by a varying radius and configured to rotate the supporting bracket about the axis of rotation with a rotational movement which deviates from a segment of a circular path.

14. The domestic appliance of claim 13, wherein the displacement slot has an elliptical limiting contour.

15. The domestic appliance of claim 13, further comprising a fixed appliance component defining the axis of rotation.

16. The domestic appliance of claim 13, further comprising a coupling element, said displacement slot being embodied as a cutout in the coupling element.

17. The domestic appliance of claim 16, wherein the coupling element is an integral part of the supporting bracket.

18. The domestic appliance of claim 17, wherein the supporting bracket includes a base part having the guiding elements, said coupling element and said base part being connected rotatably to one another.

19. The domestic appliance of claim 13, wherein the supporting bracket is rigid.

20. The domestic appliance of claim 15, wherein the appliance component is external to the supporting bracket and has a connecting structure, said displacement slot having a mechanical connecting structure which is mechanically coupled with the connecting structure of the appliance component.

21. The domestic appliance of claim 20, wherein the connecting structure of the displacement slot and the connecting structure of the appliance component complement each other and are configured as toothings which mesh with one another.

22. The domestic appliance of claim 13, wherein the supporting bracket is embodied in a U shape.

23. The domestic appliance of claim 13, wherein the guiding elements are rollers.

24. A method, comprising:
mounting a door to a housing of a household appliance for movement of the door between a closed state in which the door closes a loading opening and an opened state in which the door is lowered into a stowing space in the housing,
guiding the door during movement into and out of the stowing area via a supporting unit mounted for rotation about an axis of rotation;
rotatably mounting guiding elements on a supporting bracket of the supporting unit; and
forming the supporting bracket with a displacement slot of varying radius to enable the supporting bracket to rotate about the axis of rotation with a rotational movement which deviates from a circular path section when the door is moved.
